(19) United States
(12) Patent Application Publication
(10) Pub. No.: US 2024/0291341 A1
(43) Pub. Date: Aug. 29, 2024

(54) MOTOR

(71) Applicant: HL MANDO CORPORATION, Gyeonggi-do (KR)

(72) Inventor: Younggyu AN, Gyeonggi-do (KR)

(21) Appl. No.: 18/385,907

(22) Filed: Nov. 1, 2023

(30) Foreign Application Priority Data
Feb. 27, 2023 (KR) 10-2023-0026355

(51) Int. Cl. H02K 5/04

(52) U.S. Cl. CPC H02K 5/04

(57) ABSTRACT

A motor comprises a stator having a plurality of split cores coupled to one another, each split core including a tooth part and a yoke part; and a housing accommodating the stator in the housing. The motor can secure assembly stability while reducing friction torque due to the magnetic flux leaking from the stator to the housing.

### CROSS-REFERENCE TO RELATED APPLICATION

This application claims priority from Korean Patent Application No. 10-2023-0026355, filed on Feb. 27, 2023, which is hereby incorporated by reference for all purposes as if fully set forth herein.

### BACKGROUND

### Technical Field

Some embodiments of the present disclosure generally relate to a motor and, more specifically, to a motor capable of reducing friction torque due to the magnetic flux leaking to a housing from a stator and securing assembly stability.

### Description of Related Art

In general, a motor includes a coil-wound stator and a rotor coupled with a permanent magnet to generate rotational power. The rotor is coupled to a rotation shaft, and the stator is fixed to the inner surface of the housing, outside of the rotor.

The motor has a structure of rotating the rotor by the magnetic force generated as electricity is supplied to the coil of the stator. The magnetic force generated from the coil may leak to the housing, acting as friction torque.

### BRIEF SUMMARY

Various embodiments of the present disclosure have been conceived and relate to a motor capable of reducing friction torque due to the magnetic flux leaking to the housing from the stator and securing assembly stability.

According to some embodiments of the present disclosure, there may be provided a motor comprising a stator formed by coupling a plurality of split cores including a tooth part and a yoke part and a housing receiving the stator and having a plurality of inner grooves formed in an inner surface contacting the yoke part.

According to certain embodiments of the present disclosure, there may be provided a motor comprising a stator formed by coupling a plurality of split cores including a tooth part and a yoke part and having one or more outer grooves formed in an outer surface of the yoke part and a housing receiving the stator.

According to some embodiments of the present disclosure, it is possible to secure assembly stability while reducing friction torque due to the magnetic flux leaking from the stator to the housing.

### DESCRIPTION OF DRAWINGS

The above and other objects, features, and advantages of the disclosure will be more clearly understood from the following detailed description, taken in conjunction with the accompanying drawings, in which:

FIG. 1 is a front view illustrating a motor according to an embodiment of the present disclosure;

FIG. 2 is enlarged views illustrating a motor according to embodiments of the present disclosure;

FIG. 3 is cross-sectional views illustrating a motor according to embodiments of the present disclosure;

FIG. 4 is an enlarged view illustrating a motor according to an embodiment of the present disclosure;

FIG. 5 is an enlarged view illustrating a motor according to an embodiment of the present disclosure;

FIG. 6 is enlarged views illustrating a motor according to embodiments of the present disclosure; and

FIG. 7 is enlarged views illustrating a motor according to embodiments of the present disclosure.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B) ” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after, ” “subsequent to, ” “next, ” “before, ” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

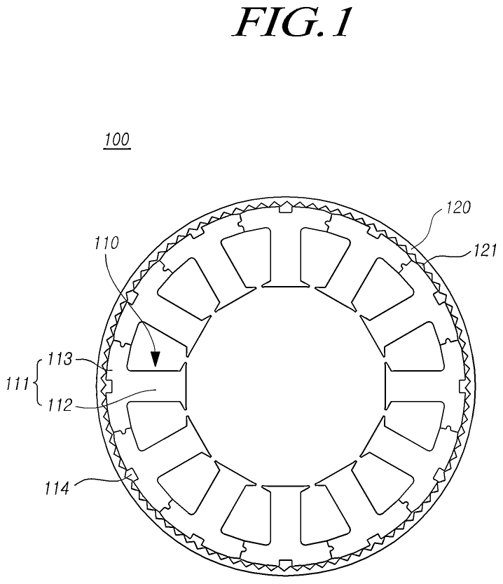

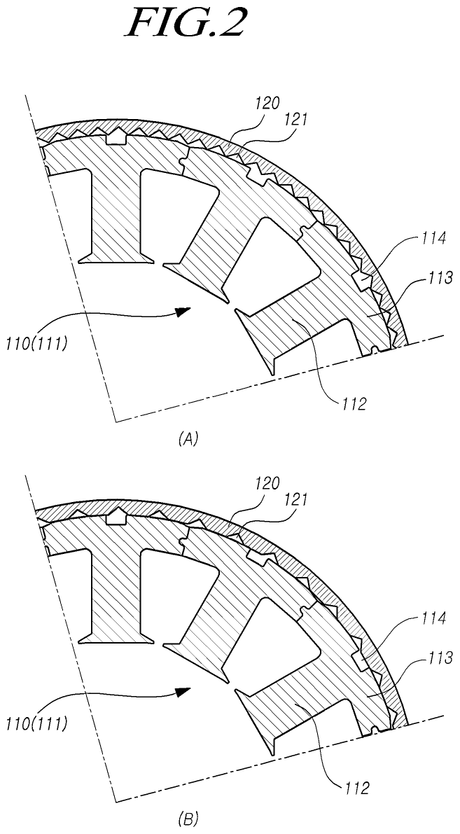

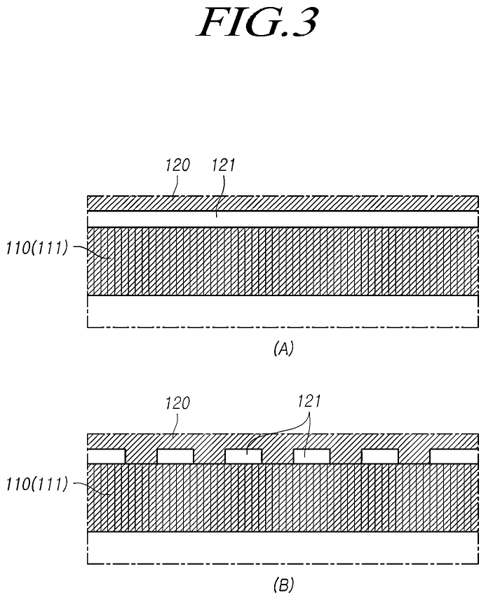

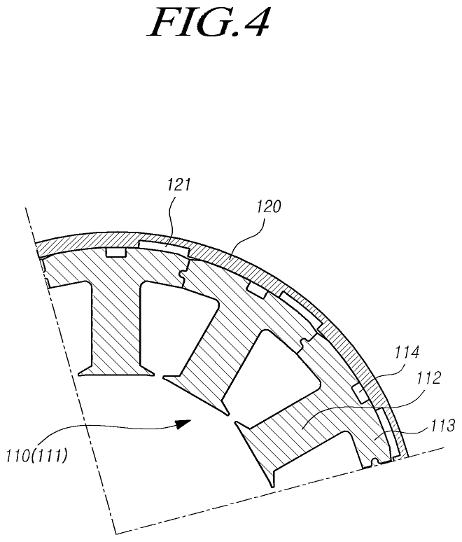

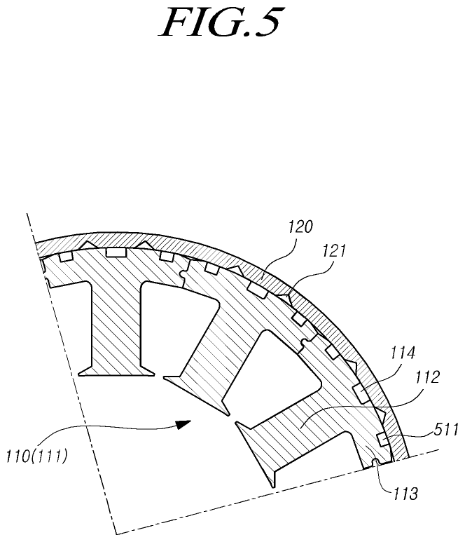

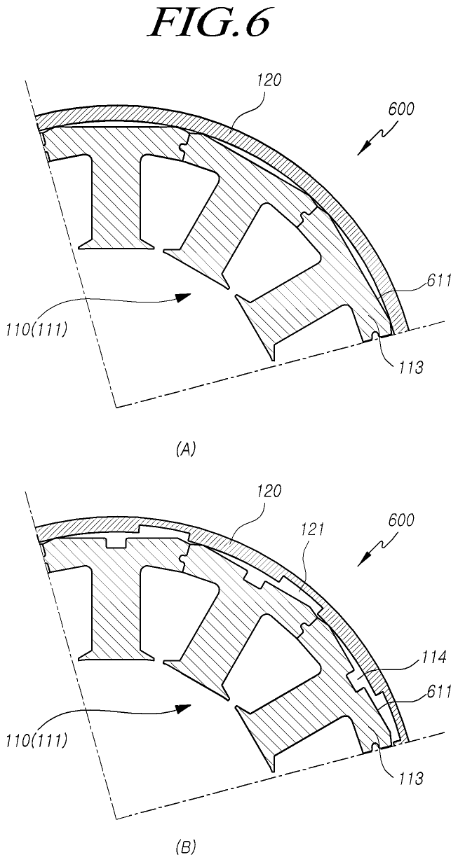

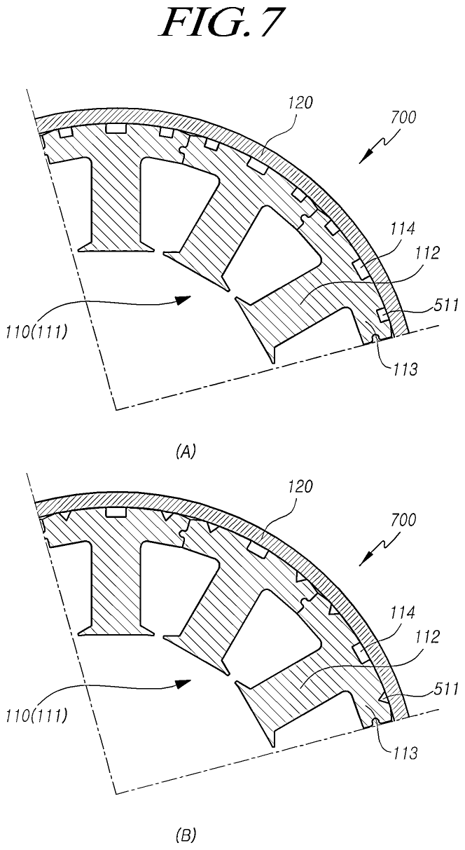

FIG. 1 is a front view illustrating a motor according to an present embodiment of the present disclosure. FIG. 2 is enlarged views illustrating a motor according to embodiments of the present disclosure. FIG. 3 is cross-sectional views illustrating a motor according to embodiments of the present disclosure. FIG. 4 is an enlarged view illustrating a motor according to an embodiment of the present disclosure. FIG. 5 is an enlarged view illustrating a motor according to an embodiment of the present disclosure. FIG. 6 is enlarged views illustrating a motor according to embodiments of the present disclosure. FIG. 7 is enlarged views illustrating a motor according to embodiments of the present disclosure.

Referring to FIG. 1, a motor 100 according to the present embodiments includes a stator 110 formed by coupling a plurality of split cores 111 including a tooth part 112 and a yoke part 113 and a housing 120 receiving the stator 110 and having a plurality of inner grooves 121 formed in an inner surface contacting the yoke part 113.

The motor 100 according to the present embodiments includes a stator 110 and a housing 120. A coil is wound around the tooth part 112 of the stator 110, and the rotor is rotated by a magnetic force generated by supplying a current to the coil. The rotor is positioned inside the stator 110, and is omitted for convenience of illustration. The rotor is provided with a plurality of permanent magnets, and the rotor is coupled to a rotation shaft. Accordingly, the rotor is rotated by a magnetic force generated from the coil to which the current is applied.

The stator 110 is formed by coupling the plurality of split cores 111, and each of the split cores 111 includes a tooth part 112 and a yoke part 113. The yoke part 113 has protrusions and recesses to be engaged with and coupled to another yoke part 113, and the split cores 111 are coupled in the circumferential direction to form one plate. A plurality of plates are stacked to form the stator 110, and a coil is wound around the stacked tooth parts 112. The yoke part 113 is provided with a notch 114 for fixing the split core 111 to a jig when the split cores 111 are coupled to each other, which is described below.

The housing 120 receives the stator 110, and a rotor positioned inside the stator 110 is also positioned inside the housing 120. The rotation shaft to which the rotor is coupled may be rotatably coupled to the housing 120 by, e.g., a bearing. According to an embodiment, the housing 120 may be formed of steel.

In the stator 110, the outer surface of the yoke part 113 is supported on the inner surface of the housing 120 and is coupled to the housing 120. According to an embodiment, the housing 120 and the stator 110 may be coupled by press-fitting. A plurality of inner grooves 121 are formed in the inner surface of the housing 120 on which the yoke part 113 is supported. As the inner grooves 121 are formed in the housing 120, the contact area between the housing 120 and the stator 110 is reduced.

As the contact area between the housing 120 and the stator 110 is reduced, the magnetic flux that leaks to the housing 120 when the current is applied to the coil may be reduced, and the friction torque may be reduced. The housing may be formed of aluminum, which is a non-magnetic material, to reduce friction torque, but aluminum has the high cost and thus increases the manufacturing cost of the motor. The housing and the stator may be bonded with a large assembly gap while forming the housing of steel, but this way may suffer from reduced assembly rigidity. However, according to some embodiments of the present disclosure, it is possible to reduce the leaking magnetic flux and friction torque by reducing the contact area between the housing 120 and the stator 110 even when the housing 120 is formed of steel which is relatively cheap. Further, since there is no increase in the assembly gap between the housing 120 and the stator 110 and no bonding therebetween, assembly stability is not deteriorated.

According to an embodiment, the inner grooves 121 may be arranged in a circumferential direction in the inner surface of the housing 120. According to an embodiment, as illustrated in FIG. 2 (A), the inner grooves 121 may be arranged adjacent to each other in the circumferential direction. According to an embodiment, as illustrated in FIG. 2 (B), the inner grooves 121 may be arranged to be spaced apart in the circumferential direction. Considering the amount of magnetic flux leaking to the housing 120 and the assembly stability of the housing 120 and the stator 110, the circumferential width of the inner groove 121 and the circumferential interval between inner grooves 121 may be adjusted.

According to an embodiment, as illustrated in FIG. 3 (A), each of the inner grooves 121 may be formed from one end to the other end in the axial direction of the housing 120. The inner groove 121 is parallel to the axial direction and may be formed from one end to the other end of the housing 120 in the axial direction. Alternatively, the inner groove 121 is not parallel to the axial direction and may be formed from one end to the other end of the housing 120 in the axial direction. For example, the inner groove 121 may be formed in a spiral shape.

According to an embodiment, as illustrated in FIG. 3 (B), the inner grooves 121 may be arranged to be spaced apart in the axial direction. The interval between the inner grooves 121 arranged in the axial direction may be constant or may not be constant. Considering the amount of magnetic flux leaking to the housing 120 and the assembly stability of the housing 120 and the stator 110, the axial length of the inner groove 121 and the axial interval between inner grooves 121 may be adjusted.

According to an embodiment, as illustrated in FIG. 2, the inner groove 121 may have a triangular groove shape. According to an embodiment, as illustrated in FIG. 4, the inner groove 121 may have a rectangular groove shape. According to an embodiment, the inner groove 121 may have a polygonal groove shape. The shape of the inner groove 121 is not particularly limited, and may be appropriately selected in consideration of the leaking flux amount and assembly stability.

Referring to FIG. 5, according to an embodiment, one or more outer grooves 511 may be formed in the outer surface of the yoke part 113. In other words, the contact area between the housing 120 and the stator 110 may be reduced not only by forming the inner grooves 121 in the inner surface of the housing 120, but also by forming the outer grooves 511 in the outer surface of the yoke part 113. One or more outer grooves 511 may be formed in the outer surface of the yoke part 113 for each split core 111 forming the stator 110.

The yoke part 113 is provided with a notch 114 for fixing the split core 111 to the jig when the split core 111 is coupled, and the contact area between the housing 120 and the stator 110 may be reduced by further forming the outer grooves 511 in addition to the notch 114. According to an embodiment, the notch 114 may be formed in the central portion of the outer surface of the yoke part 113, and the outer grooves 511 may be provided on two opposite sides of the notch 114. In other words, two outer grooves 511 may be formed at two opposite ends of the yoke part 113 with the notch 114 interposed therebetween in one split core 111.

According to an embodiment, the inner groove 121 and the outer groove 511 may be provided not to overlap in the radial direction. In other words, as illustrated in FIG. 5, the inner groove 121 of the housing 120 and the outer groove 511 of the stator 110 may be positioned at different positions in the circumferential direction. By providing the inner groove 121 and the outer groove 511 at different positions in the circumferential direction, the contact area between the housing 120 and the stator 110 may be more effectively reduced.

According to an embodiment, as illustrated in FIG. 5, the inner groove 121 may have a triangular groove shape. According to an embodiment, the inner groove 121 may have a rectangular groove shape. According to an embodiment, the inner groove 121 may have a polygonal groove shape. The shape of the outer groove 511 is not particularly limited, and may be appropriately selected in consideration of the leaking flux amount and assembly stability.

Referring to FIG. 6, according to an embodiment, a chamfered portion 611 may be formed on the outer surface of the yoke part 113. The chamfered portion 611 is formed, two opposite ends of the yoke part 113 are supported by the housing 120, and the portion between the two opposite portions supported by the housing 120 are spaced apart from the housing 120, so that the contact area between the housing 120 and the stator 110 is reduced. The notch 114 may be formed in the chamfered portion 611. The chamfered portion 611 may be formed as a flat surface as illustrated in the drawings, or may be formed with a curvature lower than that of the inner surface of the housing 120.

Referring to FIG. 7, a motor 700 according to the present embodiments includes a stator 110 formed by coupling a plurality of split cores 111 including a tooth part 112 and a yoke part 113 and having one or more outer grooves 511 formed in an outer surface of the yoke part 113 and a housing 120 receiving the stator 110. Since the contact area between the housing 120 and the stator 110 is reduced by the outer grooves 511, even if the housing 120 is formed of a magnetic material, the leaking magnetic flux to the housing 120 is reduced, and thus the friction torque is reduced. Further, since there is no increase in the assembly gap between the housing 120 and the stator 110 and no bonding therebetween, assembly stability is not deteriorated. The same reference numerals are used to denote the same elements as those in the embodiment shown in FIG. 1, with the description simplified.

According to an embodiment, the housing 120 is formed of steel. According to an embodiment, the housing 120 and the stator 110 are coupled by press-fitting.

According to an embodiment, the outer groove 511 has a triangular groove or a rectangular groove shape.

According to an embodiment, the outer groove 511 has a polygonal groove shape.

According to an embodiment, the notch 114 is formed in the center of the outer surface of the yoke part 113, and the outer grooves 511 are provided on two opposite sides of the notch 114.

According to an embodiment, a plurality of inner grooves 121 are formed in the inner surface of the housing 120 contacting the yoke part 113.

According to an embodiment, the inner groove 121 and the outer groove 511 are provided not to overlap in the radial direction.

By the shapes and configuration of the motor described above, it is possible to secure assembly stability while reducing friction torque due to the magnetic flux leaking from the stator to the housing.

Further, the motor according to the present embodiments may be a motor for a vehicle, and more specifically, may be a motor of a power-assisted steering device.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. A motor, comprising:
a stator comprising a plurality of split cores coupled to one another, each split core including a tooth part and a yoke part; and
a housing accommodating the stator in the housing and having a plurality of inner grooves formed in an inner surface of the housing contacting the yoke part of the stator.

2. The motor of claim 1, wherein the housing comprises steel.

3. The motor of claim 1, wherein the housing and the stator are press-fitted to each other.

4. The motor of claim 1, wherein the inner grooves are circumferentially arranged in the inner surface of the housing.

5. The motor of claim 1, wherein each of the inner grooves is extended from one end to another end of the housing in an axial direction of the housing.

6. The motor of claim 1, wherein the inner grooves formed in the inner surface of the housing are in a triangular or rectangular shape.

7. The motor of claim 1, wherein the inner grooves formed in the inner surface of the housing are in a polygonal shape.

8. The motor of claim 1, wherein one or more outer grooves are formed in an outer surface of the yoke part of the stator.

9. The motor of claim 8, wherein a notch is formed in a central portion of the outer surface of the yoke part of the stator, and between the outer grooves formed in the outer surface of the yoke part of the stator.

10. The motor of claim 8, wherein the inner grooves of the housing and the outer grooves of the yoke part of the stator are do not overlap each other.

11. The motor of claim 8, wherein the outer grooves formed in the outer surface of the yoke part of the stator are in a triangular or rectangular shape.

12. The motor of claim 8, wherein the outer grooves formed in the outer surface of the yoke part of the stator are shaped in a polygonal shape.

13. The motor of claim 1, wherein a chamfered portion is formed on the outer surface of the yoke part of the stator.

14. A motor, comprising:
a stator comprising a plurality of split cores coupled to one another, each split core including a tooth part and a yoke part, wherein the stator has one or more outer grooves formed in an outer surface of the yoke part; and
a housing accommodating the stator in the housing.

15. The motor of claim 14, wherein the housing comprises steel.

16. The motor of claim 14, wherein the housing and the stator are press-fitted to each other.

17. The motor of claim 14, wherein the outer grooves formed in the outer surface of the yoke part of the stator are in a polygonal shape.

18. The motor of claim 14, wherein a notch is formed in a central portion of the outer surface of the yoke part of the stator, and between the outer grooves formed in the outer surface of the yoke part of the stator.

19. The motor of claim 14, wherein a plurality of inner grooves are formed in an inner surface of the housing contacting the yoke part of the stator.

20. The motor of claim 19, wherein the inner grooves of the housing and the outer grooves of the yoke part of the stator do not to overlap each other.
